(19) United States
(12) Patent Application Publication
(10) Pub. No.: US 2017/0167890 A1
(43) Pub. Date: Jun. 15, 2017

(54) SYSTEM AND METHOD FOR PROVIDING A PLATFORM FOR DETECTING PATTERN BASED IRRIGATION

(71) Applicant: Watersmart Software, Inc., San Francisco, CA (US)

(72) Inventors: Douglas Flanzer, Burlingame, CA (US); Chris Inkpen, State College, PA (US); William Holleran, San Francisco, CA (US); Gareth Ivatt, San Francisco, CA (US)

(21) Appl. No.: 15/372,173

(22) Filed: Dec. 7, 2016

Related U.S. Application Data
(60) Provisional application No. 62/264,860, filed on Dec. 9, 2015.

(51) Int. Cl. G01D 4/00

(52) U.S. Cl. CPC G01D 4/002

(57) ABSTRACT

A system is disclosed for providing a platform for detecting pattern-based irrigation. The system comprises a data storage area to store: a property database, wherein information relating to the one or more properties is stored; and a water usage database, wherein information pertaining to water usage of one or more properties is stored; and one or more servers coupled to the data storage area, wherein the one or more servers are programmed to execute computer program steps, the computer program steps comprising: receiving first water and second usage rates corresponding to first and second points in time, respectfully from the water usage database relating to a property of the one or more properties; calculating a range as a function of a percentage of the first usage rate so as to avoid incorrectly characterizing the first usage rate as an irrigation event; comparing a similarity between the first and second water usage rates as a function of a percentage of the first water usage rate; determining if the second water usage rate is within the range; and determining a likelihood that first water usage rate is an irrigation event as a function of the whether the second usage rate is within the range.

### CROSS-REFERENCE TO RELATED APPLICATIONS

This application claims priority to U.S. provisional application No. 62/264,860, filed on Dec. 9, 2015 entitled “System and Method for Providing a Platform for Detecting Pattern Based Irrigation” which is incorporated by reference herein.

### FIELD OF THE INVENTION

The present invention relates to a system and method for providing a platform for detecting pattern-based irrigation.

### BACKGROUND OF THE INVENTION

Many regions in the U.S. and elsewhere are suffering from a severe drought. The water utility industry has determined that irrigation is among the primary uses of water on a property with outdoor landscape such as a household or commercial entity. In an attempt to address regional water shortages, water utilities (and other entities) that provide water to households and businesses may require water conservation. The water utilities have faced considerable challenges in addressing this task because water conservation requires accurate information on how water is actually being used. In an effort to gather accurate data of water consumption, water utilities have deployed smart meters (advanced metering infrastructures (AMI)) on a large scale to measure water usage data. However, these smart meters do not provide any indication of water end-use type or detail.

It would therefore be advantageous to provide a method and system to overcome the disadvantages described above.

### SUMMARY OF THE INVENTION

A system and method for providing a platform for detecting pattern-based irrigation are disclosed.

In accordance with an embodiment of the present disclosure, a system is disclosed for providing a platform for detecting pattern-based irrigation. The system comprises a data storage area to store: a property database, wherein information relating to the one or more properties is stored; and a water usage database, wherein information pertaining to water usage of one or more properties is stored; and one or more servers coupled to the data storage area, wherein the one or more servers are programmed to execute computer program steps, the computer program steps comprising: receiving first water and second usage rates corresponding to first and second points in time, respectfully from the water usage database relating to a property of the one or more properties; calculating a range as a function of a percentage of the first usage rate so as to avoid incorrectly characterizing the first usage rate as an irrigation event; comparing a similarity between the first and second water usage rates as a function of a percentage of the first water usage rate; determining if the second water usage rate is within the range; and determining a likelihood that first water usage rate is an irrigation event as a function of the whether the second usage rate is within the range.

In accordance with yet another embodiment of the disclosure, a system is disclosed for providing a platform for detecting pattern-based irrigation, the system comprising: a data storage area to store: a water usage database, wherein information pertaining to water usage of one or more properties is stored; and one or more servers coupled to the data storage area, wherein the one or more servers are programmed to execute computer program steps, the computer program steps comprising: retrieving first and second water usage rates corresponding to first and second intervals from the water usage database relating to a property of the one or more properties; comparing the first and second water usage rates corresponding to the first and second intervals; and determining a likelihood that first water usage rate is an irrigation event as a function of the comparison.

In yet another embodiment of the disclosure, a system is disclosed for providing a platform for detecting pattern-based irrigation, the system comprising: a data storage area to store: a property database, wherein information relating to the one or more properties is stored; and a water usage database, wherein information pertaining to water usage of one or more properties is stored; and one or more servers coupled to the data storage area, wherein the one or more servers are programmed to execute computer program steps, the computer program steps comprising: receiving first water and second usage rates corresponding to first and second points in time, respectfully from the water usage database relating to a property of the one or more properties; calculating a range as a function of a percentage of first usage rate so as to avoid falsely characterizing the first usage rate as an irrigation event; comparing similarity between the first and second water usage rates as a percentage of the first water usage rate; determining if the second water usage rate is within the range; assigning a first value to the first usage rate if the second usage rate falls within the range; determining a likelihood that first water usage rate is an irrigation event as a function of the whether the second usage rage is within the range.

In yet another embodiment of the disclosure, a method is provided of providing a platform for detecting pattern-based irrigation with respect to a user's property, wherein the method is implemented in one or more servers programmed to execute the method the method comprising: receiving first water and second usage rates on the user's property corresponding to first and second points in time, respectfully relating to water usage on the user's property; calculating a range as a function of a percentage of first usage rate so as to avoid falsely characterizing the first usage rate as an irrigation event; comparing a similarity between the first and second water usage rates as a percentage of the first water usage rate; determining if the second water usage rate is within the range; and determining a likelihood that first water usage rate is an irrigation event as a function of the whether the second usage rate is within the range.

### BRIEF DESCRIPTION OF THE DRAWINGS

FIG. 1 depicts a block diagram of an example system in which a platform for detecting pattern-based irrigation operates.

FIG. 2 depicts a flow diagram of example method steps of the platform shown in FIG. 1.

FIG. 3 depicts a graph illustrating an example of an hourly water usage rate under consideration as compared to hourly water usage rates at the same time of day at intervals of several different days looking both backwards and forwards.

FIG. 4 depicts a graph illustrating an example comparison for a two-hour window that includes an hourly water usage rate under consideration and the previous hourly usage rate.

FIG. 5 depicts a chart illustrating an example range of calculations and dummy variables that test for an irrigation event.

FIG. 6 depicts a chart illustrating another example of range calculations and dummy variables that test for an irrigation event (hourly rate examination).

FIG. 7 depicts a chart illustrating another example range calculations and dummy variables that test for an irrigation event (for two-hourly examination).

FIG. 8 depicts an example graph illustrating false positive percentages by irrigation.

### DETAILED DESCRIPTION OF THE INVENTION

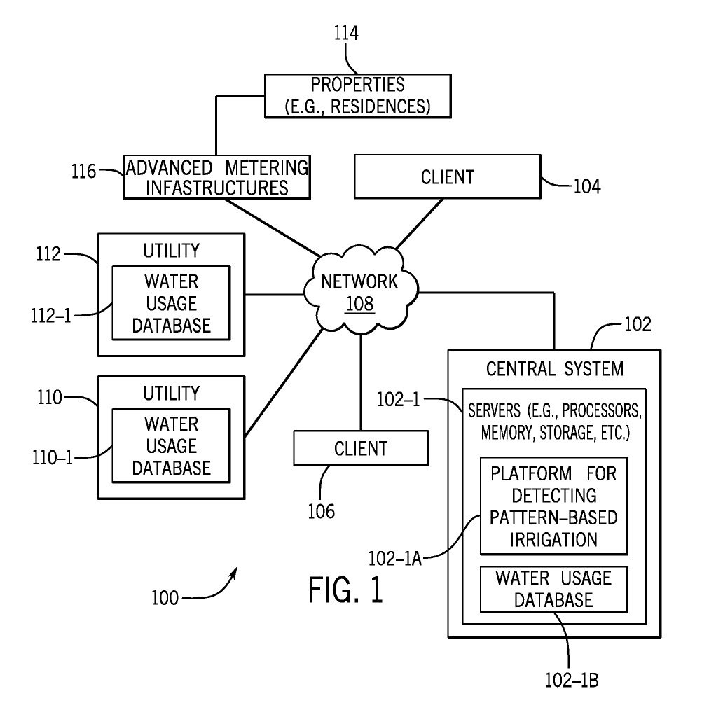

FIG. 1 depicts a block diagram of an example system 100 in which a platform for detecting pattern-based irrigation operates. (The platform is incorporated within central system 102 discussed below.). Pattern-based irrigation is defined as an automated and scheduled application of water at a given property controlled by an irrigation controller. Specifically, platform is used to detect pattern-based (e.g., medium to high) hourly water usage rates (also referred to as hourly events) that imply or indicate that a property is using a time-regulated sprinkler system (i.e., irrigating). Examples of property include a residential property (also called residence or household), commercial property, municipal property (e.g., park), industrial property, multi-family property or any other property known to those skilled in the art. Platform will discover both events of irrigation within a single hour as well as irrigation events that span multiple hours as described in more detail below.

System 100 comprises central system 102 along with clients 104, 106 that communicates (wired or wireless) with central system 102 via network 108. Network 108 may be the Internet, LAN or combination of both. System 100 further comprises utilities 110 and 112 and a number of properties 114 that are coupled to advanced metering infrastructures (AMI) 116 that enable utilities 110, 112 to collect water usage data (i.e., water usage rates). (Each AMI 116 may be mounted at various points (structure) on the owners' property. Specifically, AMI affords the utilities the opportunity to collect very detailed water usage data (e.g., hourly usage rates) of each property. The data is stored in databases 110-1, 112-1 in utilities 110 and 112, respectively. Central system 100 typically communicates with utilities 110, 112 via network 108 (wired or wireless) via an application programming interface (API) configured to access databases 110-1, 112-2 to retrieve property-specific water usage data (i.e., water usage rate).

Central system 102 includes one or more servers 102-1 (as shown). The one or more servers 102-1 may include a web server for a website, portal and/or dashboard. Each server includes several internal components (e.g., one or more processors, memory, storage drives, network or other interfaces, optional video cards, and other components as known to those skilled in the art etc.) as well as databases, software modules and applications (e.g., browser) as known to those skilled in the art. In particular, servers 102-1 incorporate platform 102-1A for detecting pattern-based irrigation as described above as well as water usage database 102-1B for storing water usage data (e.g., water usage rates received from the utilities via the API). As disclosed above, platform 102-1A is accessible by clients 104, 106 via website or dedicated application such as a dashboard.

Clients 104, 106 each may be a personal computer and a monitor or mobile devices such as smartphones, cellular telephones, tablets, PDAs, or other devices equipped with industry standard (e.g., HTML, HTTP etc.) browsers or any other application having wired (e.g., Ethernet) or wireless access (e.g., cellular, Bluetooth, RF, WIFI such as IEEE 802.11b etc.) via networking (e.g., TCP/IP) to nearby and/or remote computers, peripherals, and appliances, etc. TCP/IP (transfer control protocol/Internet protocol) is the most common means of communication today between clients or between clients and systems (servers), each client having an internal TCP/IP/hardware protocol stack, where the “hardware” portion of the protocol stack could be Ethernet, Token Ring, Bluetooth, IEEE 802.11b, or whatever software protocol is needed to facilitate the transfer of IP packets over a local area network. The personal computer or mobile device (client 104 or client 106) includes internal components such as a processor, memory, storage drives, interfaces, optional video cards, and other components as known to those skilled in the art etc. There are two clients shown in FIG. 1, but those skilled in the art know that any number of clients may be used.

As described above, utilities 110, 112 provide water and other utilities to residences and businesses as known to those skilled in the art. There are two shown in FIG. 1, but those skilled in the art know that any number of utilities may be used.

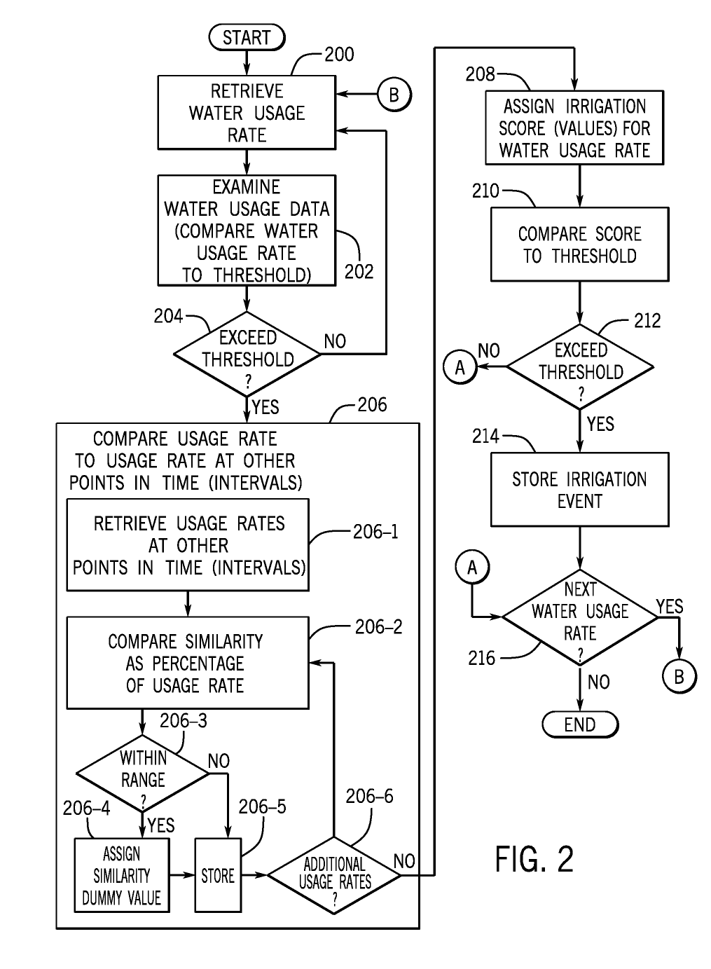

FIG. 2 depicts a flow diagram of example method steps of platform 102-1 shown in FIG. 1. In particular, execution beings with step 200 wherein a water usage rate (event) is retrieved. In one example, the water usage rate is an hourly usage rate at T₀. In another example, the usage rate is a summation of two neighboring hourly usage rates at T₀ and at T_{-1 hour}.

Execution then proceeds to step 202 wherein the water usage rate is examined. That is, water usage rate (e.g., at T₀ for hourly or T₀ and at T_{+/-1 hour} for two-hour) is compared to a threshold (user defined, e.g., utility-specific threshold). The threshold is a minimum level in which a water usage rate may be eligible for consideration as an irrigation event. That is, the threshold acts as a filter to remove water usage rates that clearly do not constitute irrigation events that the algorithm should predict. A user may set the threshold based on his/her own knowledge and experience of indoor property-specific water usage rates. Alternatively, the threshold may be selected based a process known to those skilled in the art for optimizing the threshold parameter. The threshold-optimization process employs comparing the sample usage rate data accumulated over time against actual false positive percentages for irrigation events at those rates. Values for the threshold are varied to a point where the water usage rates (events) are not misclassified (i.e., identify a point at which false positive percentages markedly increase). For example, if a residential-property does not exceed 50 gallons per hour (gph), then this usage rate is likely not an irrigation event. In practice, rates below 50 gph are largely not considered irrigation events to those skilled in the art because they are too low to constitute outdoor water usage. For two-hour rates, 150 gph may be selected as the threshold. A threshold may be set by a user such as a water utility or research team.

Execution proceeds to decision step 204 wherein it is determined if the specific usage rate actually exceeds that threshold established above. If the water usage rate does not exceed the threshold execution returns to step 200.

If the usage rate does exceed the threshold, execution proceeds to step 206 wherein the water usage rate (event) is compared to a property's usage rates (observations) at other points in time (pre-set intervals), looking both forward and backward in time (from that usage rate date) in order to pick up temporal usage patterns. For hourly comparisons, water usage rate at time T₀ is compared to the water rate at the same hourly intervals on different days looking backwards and forwards. For two-hourly comparisons, the summation of two hourly rates (e.g., T₀ and at T_{+/-1 hour}) is compared with preset-set two-hour intervals to find similarities that indicate irrigation is occurring over multiple hours. Step 206 is essentially broken down in detail as follows.

Specifically, execution proceeds to step 206-1 wherein usage rates at different points in time (e.g., other than T₀) are retrieved. A table appears below with measured example usage rates.

| | | | PERCENTAGE OF |
|---|---|---|---|
| DAY | TIME | USAGE RATE (gph) | USAGE T₀ |
| MON (T₀) | 8 AM | 100 | 100% |
| SAT (T₊₅) | 8 AM | 67 | 67% |
| FRI (T₊₁₁) | 8 AM | 94 | 94% |
| WED (T₊₁₆) | 8 AM | 102 | 102% |
| MON (T₊₂₁) | 8 AM | 95 | 95% |

As can be viewed above, the usage rate (gph) is measured at different points in time before and after point T₀ (as a reference). The different points in time are effectively the same time on different dates. For the example above in the table, the usage rate at reference T₀ is 100 gph and the percentage of usage at points in time before and after are converted based on the usage rate T₀ at the reference point. In this case, a measurement at 8 AM on SAT (Saturday, (T₊₅)) is 67% (as compared to the gph at the reference point T₀). Execution proceeds to step 206-2 wherein the similarity between usage rate measured at T₊₅ (i.e., the same time of day, 5 days following the time T₀) and reference T₀ are compared as a percentage of usage rate at T₀. (Alternatively, the process may employ any number of days of the week before and after T₀ as known to those skilled in the art. E.g., T₋₁₄, T₋₇, T₋₃, T₋₂, T₂, T₃, T₇, T₁₄.)

As part of this comparison, a range is calculated to determine whether or not the water usage rate (or summation of two hourly rates) for the previous or subsequent point in time (interval) is within plus or minus a percentage of the rate (gallon amount) under consideration. The percentage is selected to ensure false positives for irrigation events remain low. The higher the percentage selected, the more likely a rate will be flagged as an indoor usage event (non-irrigation event) as known to those skilled in the art. The percentage may be based on sample water usage data set from a resident in the winter or wet-season when it is known that irrigation events do not occur. Using such data, a value for the percentage is purposely varied (for a range) to optimize the percentage (parameter) in order to avoid misclassifying an event (water usage rate) as known to those skilled in the art.

In one example, the percentage for the range may be plus or minus ten percent (i.e., a range of 90% to 110% stated differently) to create the boundaries of the range. However, those skilled in the art know that any other percentage may be used to achieve desired result. Initially for both hourly rate or two-hourly rate comparisons, the water usage rate at time T₋₁ or T₊₁ is retrieved, percentage of usage rate determined and a range is calculated to determine whether or not the percentage of usage rate at T₀ (or summation of two hourly rates, e.g., at T₀ and at T_{-1 hour}) for that previous or subsequent points in time (intervals) is within plus or minus a ten percent (or other pre-determined boundary condition) of the percentage of rate under consideration (i.e., T₋₁ or T₊₁). As indicated above, usage rates are retrieved (i.e., received) that correspond to the usage rate at the same time (interval) or summation of two hourly rates) on a different day. (While usage rates at other times are retrieved at this point in step 206-1, those skilled in the art know that all usage rates may be retrieved at a different part of the process than that described to achieve the same results.)

Alternatively, a range may be calculated directly from the actual reference usage rate T₀. For example, a retrieved hourly rate at T₀ is 281 gallons per hour (gph) and the water usage rate at T₋₁ is 275 gph, then a range is calculated to be between 247.5 and 302.5 (10% below and above the usage rate at T₋₁). Four two-hour windows, a process similar to the hourly comparison is applied. If for example the water usage rate at T₀ is 142 gph and the water usage rate at T_{-1 hour} is 216 gph (two-hour amount is 358 gph) and T₋₁₆₈ is 145 gph and T₋₁₆₉ is 217 gph (two-hour amount is 362 gph), then the range for the two-hour window is between 325.8 and 398.2 gph (based on 10% range). This is alternatively how a range is calculated. However, the result remains the same as described above and shown in FIG. 2.

The example described above employs one range for the comparison. However, two or more ranges may be used as known to those skilled in the art. For example, a first range may be used for hourly water usage rates below 70 gph and a second range may be used for water usage rates greater than 70 gph. The ranges are tunable to achieve desired results. In order to minimize false positives, a range may be more restrictive at the lower usage levels as those are more likely to represent indoor usage. Once usage is significantly above reasonable indoor usage levels, a less restrictive range would be advisable.

Returning to the method in FIG. 2, execution then proceeds to steps 206-2 and 206-3, the percentage of usage rate is compared to the calculated range and it is determined whether the percentage of usage rate is within the calculated range described above. If the percentage of the usage rate is not within the calculated range, execution proceeds to step 206-5 wherein a null value is stored (or alternatively nothing is stored). If the percentage of usage rate falls within the calculate range, execution proceeds to step 206-4 wherein the usage rate is assigned a similarity dummy value. In one example, a dummy value is set to the value of 1. In this respect, the usage rate T₁ (as it relates to T₀) is assigned a value of 1 if the rate at T₁ falls within the calculated range. If it did not fall within the calculated range, then a value assigned would be “0.” Value assignment may be determined as desired. Execution then proceeds to step 206-5 wherein that similarity dummy value is stored.

Execution proceeds to decision step 206-6, wherein it is determined if there are additional usage rates for comparison. If so, then execution returns to step 206-2. In the example above, there are additional points in time (i.e., intervals on different days) T₋₂, T₊₂, T₋₃, T₊₃ . . . T₋₁₄, T₊₁₄.

When there are no more usage rates at different points in time (intervals) for comparison, then execution proceeds to step 208 wherein an irrigation score is assigned for the hourly usage rate at T₀ or T₀ and T_{-1 hour} for two-hourly rates. The score is a summation (Σ) of the dummy values stored at step 206-6. If the values assigned in step 206-4 are selected to be “0” or “1” then the score will have a range between 0 and 8 for hourly intervals or between 0 and 24, for two-hour intervals (looking backwards and forwards).

Execution then proceeds to step 210 wherein the irrigation score is compared to a threshold to determine if the water usage rate at T₀ constitutes an irrigation event. The threshold is selected based on a similar process for optimizing a threshold parameter as described above with respect to other thresholds. Specifically, sample hourly usage rate data from a property (e.g., a residential property) that cannot irrigate may be used. A value for this threshold is varied to a point where the water usage rates (events) are not misclassified. That is, threshold selection is based on known water usage data to avoid false positives for irrigation events. Now, if the score does exceed the threshold at decision step 212, then the water usage rate at T₀ (or T₀ and T_{-1 hour} for two-hour) is flagged (classified) as an irrigation event and it is stored at step 214. Then execution proceeds to step 216. If it does not exceed the threshold, then execution also proceeds to step 216 wherein it is determined if there are any more water usage rates to examine. If, for example, the threshold is set to 4, irrigation scores greater than or equal to 4 are flagged as an irrigation event. A threshold of 6 or more may be selected to indicate that the water usage rate is flagged as an irrigation event. A flag indicates that they have received the minimum amount of points to be considered an irrigation event based on the presence of a temporal pattern of water usage looking backwards or forwards.

If there are additional water usage rates to be considered, then execution returns to step 200. If there are no more usage rates, execution ends.

The steps set forth in FIG. 2 are summarized as an irrigation detection algorithm equation as follows:

if (Σᵢ₌₁⁸(if (|t₀−tᵢ|<0.1*t₀) then 1 else 0)) >4: then water usage rate at t₀ (T₀ above) is classified as irrigation event. If the summation is not greater than 4, then water usage rate t₀ is not classified as an irrigation event. t₀ equals water usage in gallons at time zero and tᵢ equals water usage rate at comparison 8 intervals (i.e., +/−2, 3, 7, and 14). Those skilled in the art know that variations of this formula itself or the number of intervals will achieve the same desired results.

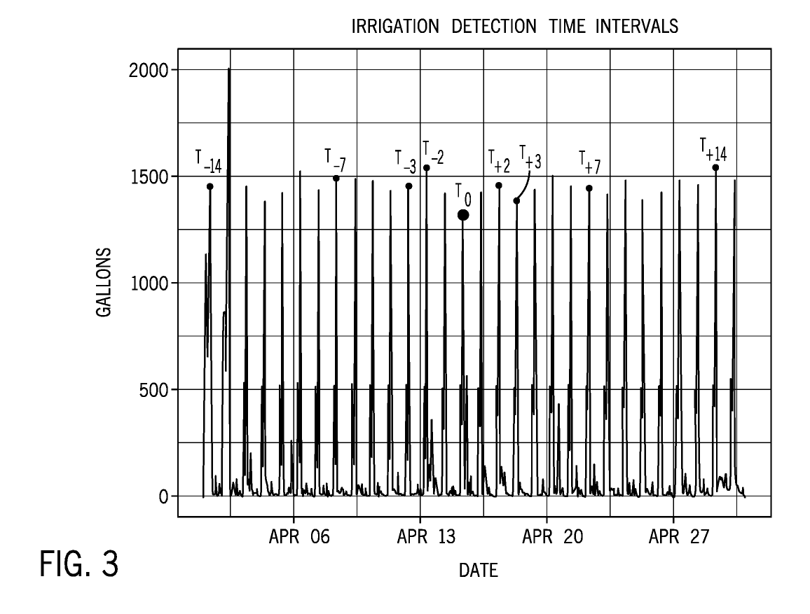

FIG. 3 depicts an a graph illustrating an hourly rate hour at T₀ under consideration as compared to the hourly rate at the same points in time (intervals) on different days looking both backwards and forwards.

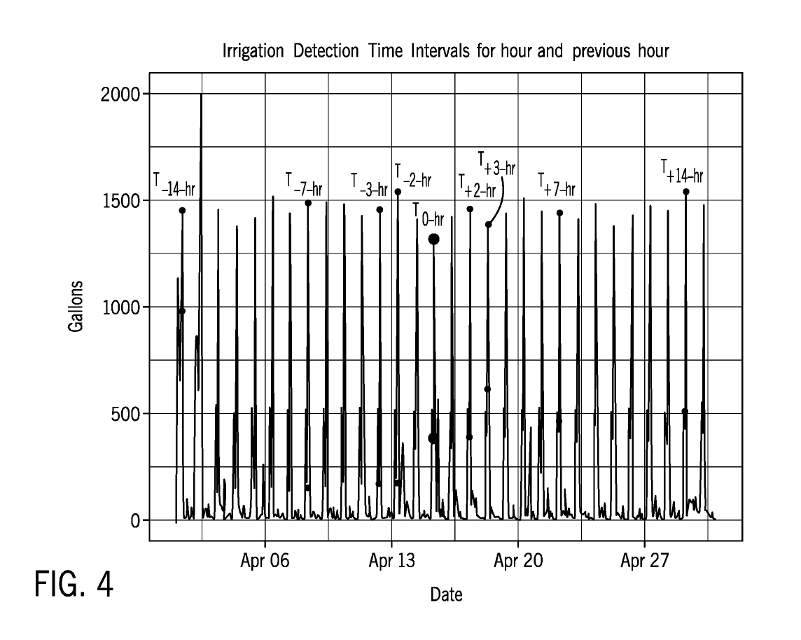

FIG. 4 depicts a graph illustrating an example comparison for the two-hour window that includes the hourly rate under consideration and the previous hour (T₀ and T_{-1 hour}, shown). The water usage rates for this two-hour window are summed and then compared against similar two-hour window water usage rates (gph) that follow the points in time (intervals) used for the single-hour comparisons looking both backwards and forwards. For example, first looking backwards, the sum of the gallon amounts for T₀ & T₋₁ hour is compared to the interval two days prior (T₋₄₈ & T₋₄₉), three days prior (T₋₇₂ & T₋₇₃), one week prior (T₋₁₆₈ & T₋₁₆₉), and two weeks prior (T₋₃₃₆ & T₋₃₃₇). Looking forwards, the T₀ & T₋₁ hour two-hour window is compared to the interval two days after (T₊₄₈ & T₊₄₇), three days after (T₊₇₂ & T₊₇₁), one week after (T₊₁₆₈ & T₊₁₆₇), and two weeks after (T₊₃₃₆ & T₊₃₃₅).

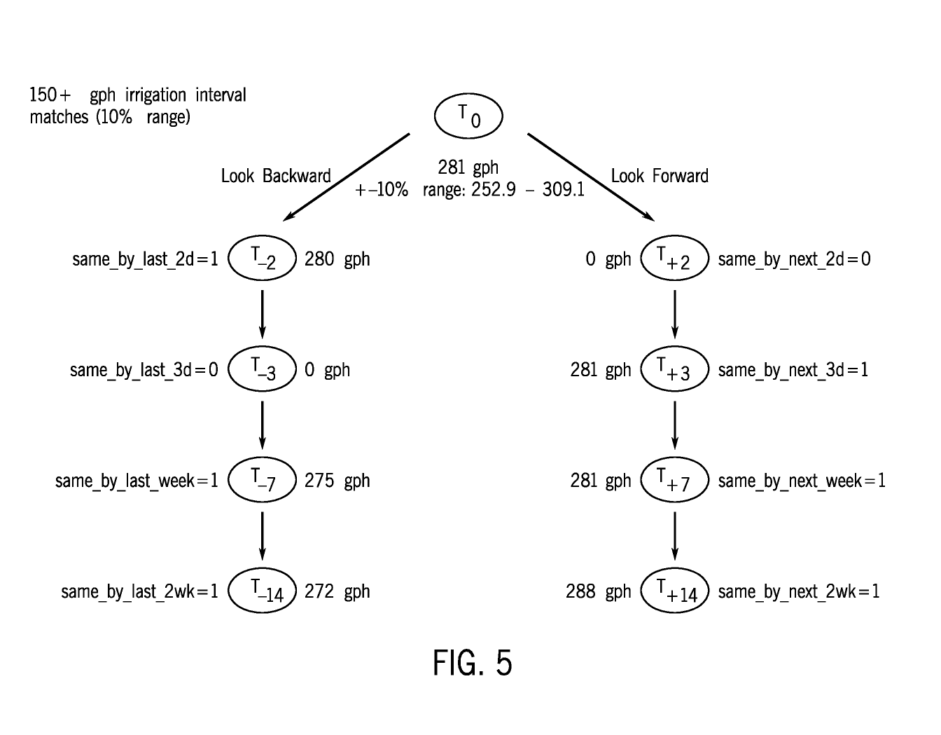

FIG. 5 depicts a chart illustrating example range calculations and dummy variables that test for an irrigation event (hourly rate examination). For example, when T₀ is 281 gph and T₋₇ is 275, then a dummy variable (same_by_last_week) is assigned a value of 1 (as the gallon amount for T₋₇ is within 252.9 and 309.1). If previous and subsequent gallon amounts (by percentage) are all within range, a single observation can have similarity dummy values of 1 for the entire series (8 out of 8). A 150 gph threshold can be parameterized to be lowered or raised based on the utility.

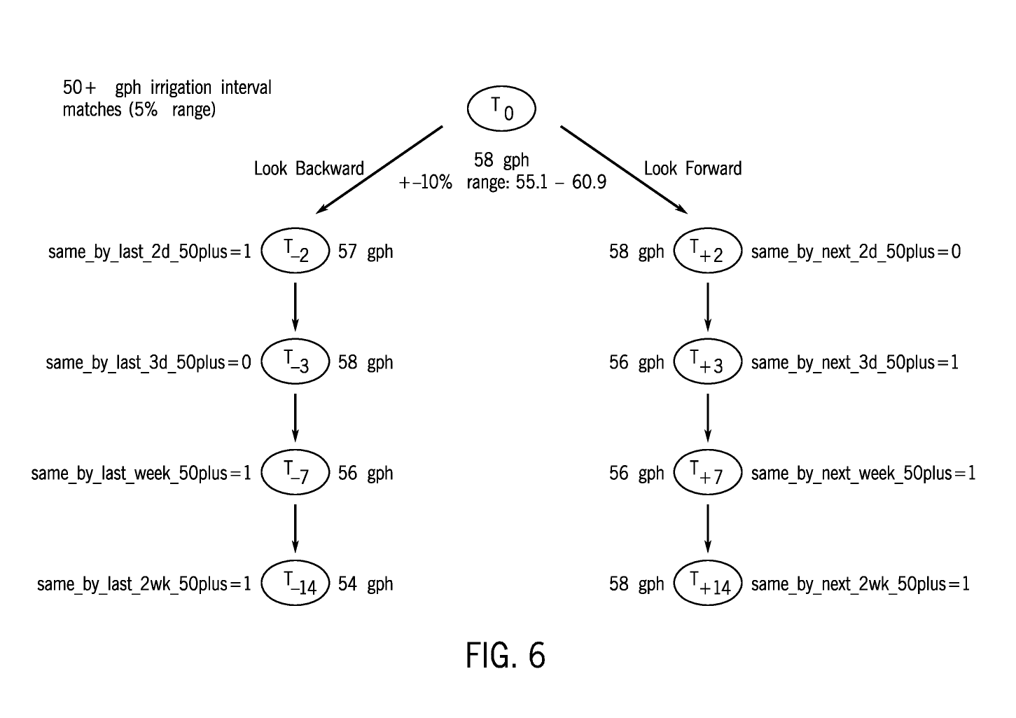

FIG. 6 depicts a chart illustrating additional example range calculations and dummy variables that test for an irrigation event (hourly rate examination). When attempting to classify lower usage hours as irrigation, a smaller comparison range is recommended. Specifically, in addition to the above, for single hour water usage rates (events) greater than or equal to 50 gph, another series of dummy variables may be created that indicate whether or not the water usage rates for the previous or subsequent periods of time (intervals) is within plus or minus 5% of the gallon amount under consideration. If the previous or subsequent amount is within this range, then the variable (e.g. ‘same_by_last_week_50plus’) has a value of “1.” Otherwise, the similarity dummy variable has a value of “0.” This calculation is performed for the previous and subsequent 2 days, 3 days, week, and 2 weeks. That is, when T₀ is 58 gph and T₋₇ is 56 gph, then the dummy variable (same_by_last_week_50plus) would be assigned a value of 1 (as the water usage rate for T₋₇ is within 55.1 and 60.9). In this way, a water usage rate (observation or event) can receive two possible irrigation points by being within a certain range. This rewards higher gallon events that happen to display patterns that are within a tight range. FIG. 6 depicts this irrigation verification visually. For example, the previous observation when T₀ is equal to 281 and T₋₇ is 275 would receive a 1 for ‘the dummy variable (same_by_last_week_50plus) as well as a 1 for another dummy variable (same_by_last_week). If previous and subsequent water usage rate are all within this 5% range, a single hourly water usage rate (event or observation) can have dummy values of 1 for the entire series (8 out of 8). Similarly, the 50 gph threshold can be parameterized to be lowered or raised based on a utility.

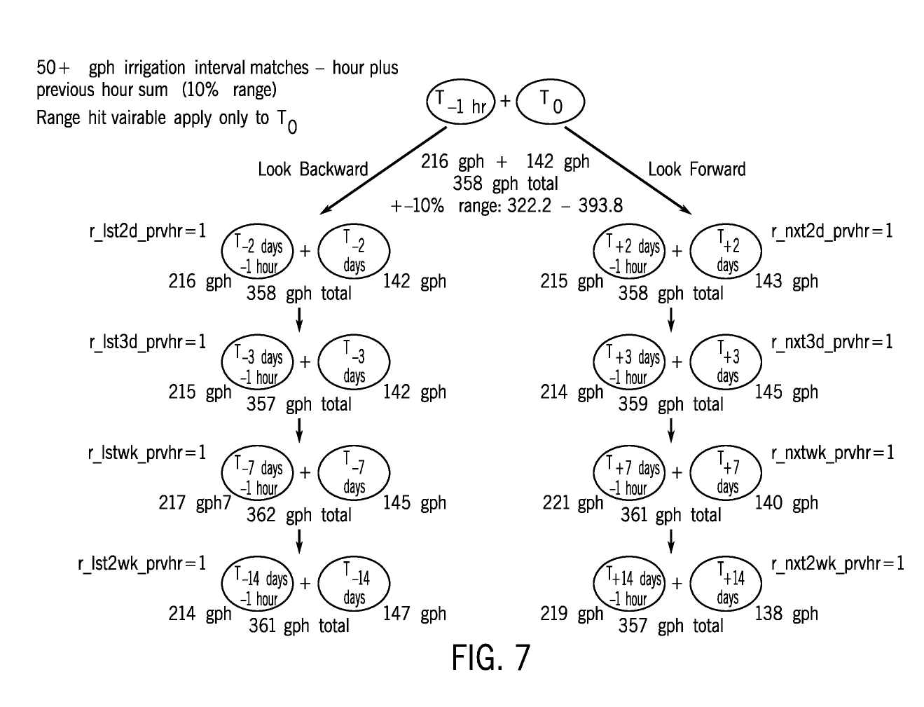

FIG. 7 depicts a chart illustrating example range calculations and dummy variables that test for two-hourly irrigation events (examination). For two-hour intervals, the hour under consideration (gal_min_leak) is summed with the previous hour gallon amount (hr_and_prev). The hour under consideration (gal_min_leak) is then summed with the subsequent hour gallon amount (hr_and_next). Two-hour windows are then created for each time interval of interest (e.g., T₋₄₈+T₋₄₉). These water usage rate windows are then compared with a similar process as single-hour irrigation events described above. If an hourly observation under consideration is greater than or equal to 50 gallons per hour (gph) and its summed neighboring two-hour window is greater than or equal to 150 gallons, then this water usage rate (interval or observation) can be considered for possible irrigation based on comparison to previous and subsequent two-hour windows. Note that the thresholds can be parameterized by utility. However, false positive testing may lead to the selection of these parameters as known to those skilled in the art. This comparison follows the previous process that creates a series of dummy variables described above. If the previous or subsequent two-hour window is within a range of plus or minus ten (10) percent, then the variable (e.g. ‘range_lstwk_prv_hrs’) has a value of ‘1’, otherwise the variable has a value of ‘0’.

For example, as in FIG. 7, if T₀ is 142 gph and T₋₁ hour is 216 gph (for a two-hour ‘hr_and_prev’ amount of 358 gph) and T₋₁₆₈ is 145 gph and T₋₁₆₉ is 217 gph (for a two-hour ‘lstwk_hr_and_prev’ amount of 362 gph), then the dummy variable (r_lstwk_prv_hrs) would be assigned a value of 1 (as the gallon amount for the two-hour window is between 322.2 and 393.8 gph). If previous and subsequent two-hour intervals are all within the plus or minus 10 percent range, a single water usage rate (observation) can have dummy values of 1 for the entire series (16 out of 16). As indicated above, a single irrigation score is simply the summation of all of the similarity dummy variables created by measuring the numerical proximity of previous and subsequent intervals (single-hour and two-hour windows).

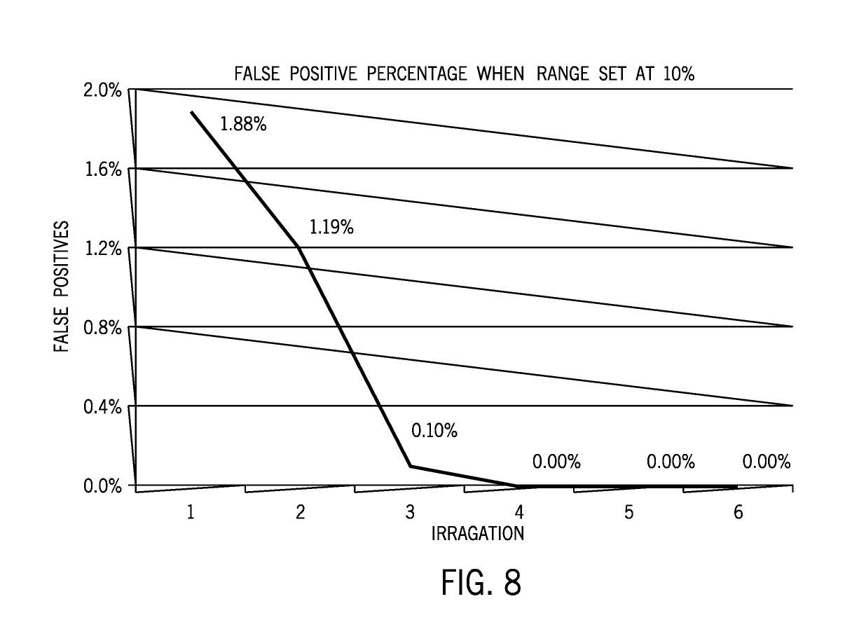

FIG. 8 depicts an example graph illustrating false positive percentages by irrigation score (using a 10% range as discussed above). False positives are primarily distributed when a threshold is set to 3 or less as irrigation score as shown. Thus, a score threshold can also be used that requires the threshold to be an irrigation score of 3 or higher to ensure that the hourly observation is a confirmed irrigation event as known to those skilled in the art. Requiring this threshold may ensure a high level of confidence in the presence of a temporal pattern while also reducing the possibility for false positives to less than 1%.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A system for providing a platform for detecting pattern-based irrigation, the system comprising:
a data storage area to store:
a property database, wherein information relating to the one or more properties is stored; and
a water usage database, wherein information pertaining to water usage of one or more properties is stored; and
one or more servers coupled to the data storage area, wherein the one or more servers are programmed to execute computer program steps, the computer program steps comprising:
receiving first water and second usage rates corresponding to first and second points in time, respectfully from the water usage database relating to a property of the one or more properties;
calculating a range as a function of a percentage of the first usage rate so as to avoid incorrectly characterizing the first usage rate as an irrigation event;
comparing a similarity between the first and second water usage rates as a function of a percentage of the first water usage rate;
determining if the second water usage rate is within the range; and
determining a likelihood that first water usage rate is an irrigation event as a function of the whether the second usage rate is within the range.

2. The system of claim 1 wherein the programs steps further comprise assigning a first value to the second usage rate if the second usage rate falls within the range.

3. The system of claim 2 wherein the program steps further comprising storing the first assigned value.

4. The system of claim 3 wherein the program steps further comprising:
retrieving a third water usage rate corresponding to a third point in time from the water usage database relating to a property of the one or more properties; and
comparing the similarity between the third water usage rate and the first usage rate as a percentage of the first water usage rate; and
determining if the third water usage rate is within the range.

5. The system of claim 4 wherein the programs steps further comprising assigning the first value to the third usage rate if the third usage rate falls within the range.

6. The system of claim 5 wherein the program steps further comprising assigning a score for the first water usage rate based on a summation of the first and second values.

7. The system of claim 6 wherein determining the likelihood includes comparing the score to a threshold so as to identify the presence of a temporal pattern with respect to the first, second and third water usage rates.

8. The system of claim 7 wherein determining the likelihood includes classifying the first water usage rate as an irrigation event if the score exceeds the threshold.

9. The system of claim 8 where in the first and second points in time are hourly or two-hour intervals.

10. A system for providing a platform for detecting pattern-based irrigation, the system comprising:
a data storage area to store:
a water usage database, wherein information pertaining to water usage of one or more properties is stored; and
one or more servers coupled to the data storage area, wherein the one or more servers are programmed to execute computer program steps, the computer program steps comprising:
retrieving first and second water usage rates corresponding to first and second intervals from the water usage database relating to a property of the one or more properties;
comparing the first and second water usage rates corresponding to the first and second intervals; and
determining a likelihood that first water usage rate is an irrigation event as a function of the comparison.

11. The system of claim 10 wherein first and second usage rates are hourly usage rates.

12. The system of claim 11 wherein the first and second usage rates are two-hourly rates.

13. A system for providing a platform for detecting pattern-based irrigation, the system comprising:
a data storage area to store:
a property database, wherein information relating to the one or more properties is stored; and
a water usage database, wherein information pertaining to water usage of one or more properties is stored; and
one or more servers coupled to the data storage area, wherein the one or more servers are programmed to execute computer program steps, the computer program steps comprising:
receiving first water and second usage rates corresponding to first and second points in time, respectfully from the water usage database relating to a property of the one or more properties;
calculating a range as a function of a percentage of first usage rate so as to avoid falsely characterizing the first usage rate as an irrigation event;
comparing similarity between the first and second water usage rates as a percentage of the first water usage rate;
determining if the second water usage rate is within the range;
assigning a first value to the first usage rate if the second usage rate falls within the range;
determining a likelihood that first water usage rate is an irrigation event as a function of the whether the second usage rage is within the range.

14. The system of claim 13 wherein the program steps further comprising storing the first assigned value.

15. The system of claim 13 wherein the program steps further comprising:
retrieving a third water usage rate corresponding to a third point in time from the water usage database relating to a property of the one or more properties; and
comparing the similarity between the third water usage rate and the first usage rate as a percentage of the first water usage rate; and
determining if the third water usage rate is within the range.

16. The system of claim 15 wherein the programs steps further comprising assigning the first value to the third usage rate if the third usage rate falls within the range.

17. The system of claim 16 wherein the program steps further comprising assigning a score for the first water usage rate based on a summation of the first and second values.

18. The system of claim 17 wherein determining the likelihood includes comparing the score to a threshold so as to identify the presence of a temporal pattern with respect to the first, second and third water usage rates.

19. The system of claim 18 wherein determining the likelihood includes classifying the first water usage rate as an irrigation event if the score exceeds the threshold.

20. A method of providing a platform for detecting pattern-based irrigation with respect to a user's property, wherein the method is implemented in one or more servers programmed to execute the method the method comprising:
receiving first water and second usage rates on the user's property corresponding to first and second points in time, respectfully relating to water usage on the user's property;
calculating a range as a function of a percentage of first usage rate so as to avoid falsely characterizing the first usage rate as an irrigation event;
comparing a similarity between the first and second water usage rates as a percentage of the first water usage rate;
determining if the second water usage rate is within the range; and
determining a likelihood that first water usage rate is an irrigation event as a function of the whether the second usage rate is within the range.
